(19) United States
(12) Patent Application Publication
(10) Pub. No.: US 2011/0199660 A1
(43) Pub. Date: Aug. 18, 2011

(54) Hologram recording medium

(75) Inventor: Akira Shirakura, Tokyo (JP)

(73) Assignees: Sony Corporation, Tokyo (JP); Sony DADC Corporation, Tokyo (JP)

(21) Appl. No.: 12/929,582

(22) Filed: Feb. 2, 2011

(30) Foreign Application Priority Data
Feb. 15, 2010 (JP) 2010-030706

(51) Int. Cl. G03H 1/02

(52) U.S. Cl. 359/3

(57) ABSTRACT

A hologram recording medium includes: a hologram recording layer; and a light scattering layer, wherein a material having a reflection characteristic different from that of a main material forming the light scattering layer is arranged in the light scattering layer.

### BACKGROUND OF THE INVENTION

1. Field of the Invention

The present invention relates to a hologram recording medium that can improve security of a hologram used for the purpose of genuineness determination.

2. Description of the Related Art

Holograms that can be stereoscopically displayed are used for genuineness determination for credit cards, personal identification cards, and the like. In recent years, as the holograms used for the purpose, a volume hologram that records an interference pattern as a difference in a refractive index on the inside of a recording layer is often used instead of an embossed hologram that records an interference pattern as unevenness on the surface thereof. This is because it is difficult to counterfeit the volume hologram compared with the embossed hologram. This is because, in the volume hologram, an advanced technology is necessary to create a recording image and it is difficult to obtain a recording material.

Since it is inefficient to manufacture volume holograms one by one using a printer, a method called contact print for copying a large number of holograms through contact copying using a hologram as a master is adopted. FIG. 17 is a schematic diagram of volume hologram copying by the contact print. A laser beam from a laser beam source 70 is expanded by a space filter 73 and made incident on a collimation lens 74. The laser beam changed to parallel rays by the collimation lens 74 is irradiated on a hologram recording medium 75 and a master 76 including photosensitive materials. The master 76 itself is also a hologram. For example, a volume hologram to which a holographic stereogram recorded on the basis of parallax images from multiple viewpoints is applied can be used for the master 76.

The hologram recording medium 75 and the master 76 having layers of the photosensitive materials are directly set in contact with each other or set in contact with each other via refractive index adjusting liquid (which is called index matching liquid). Interference fringes formed by light (S polarized light) diffracted by the master 76 and the incident laser beam are recorded on the hologram recording medium 75.

Volume holograms can be copied (mass-produced) by the contact print using the hologram master in this way. U.S. Pat. No. 5,798,850 (Patent Document 1) discloses a manufacturing method and a manufacturing apparatus for a hologram sticker by the contact print. According to Patent Document 1, it is possible to continuously and surely obtain hologram stickers through the contact print. As shown in FIG. 18 and FIGS. 19A to 19C, with the manufacturing method and the manufacturing apparatus disclosed in Patent Document 1, a hologram recording layer 900 and a protective layer 908 are integrally formed and an adhesive layer 902 and a release layer 904 are integrally formed after the contact print. A layer structure of a hologram recording medium in a P1 section of the manufacturing apparatus is shown in FIG. 19A. A layer structure of the adhesive layer 902 and release layers 904 and 944 in a P2 section of the manufacturing apparatus is shown in FIG. 19B. A layer structure of the hologram recording medium in a P3 section of the manufacturing apparatus is shown in FIG. 19C.

In this way, according to the method of the contact print, it is not impossible to further copy a volume hologram copied from a hologram master (hereinafter referred to as original master as appropriate) by setting an unexposed hologram recording material close to the hologram master and irradiating a laser having waveform near recording waveform on the hologram recording materials. In other words, it is not impossible to perform unauthorized copying by the method of the contact print using a hologram not subjected to any measures for counterfeit prevention as a master.

Therefore, there is a demand for measures for making it difficult to perform unauthorized copying using a hologram legally coped from an original master, i.e., a genuine hologram as a master or making it possible to see that a hologram further copied in an unauthorized manner by using the genuine hologram as the master is different from the genuine hologram. In this case, means for preventing unauthorized copying is desirably configured not to interfere with an observation of hologram images.

JP-UM-A-4-94481 (Patent Document 2) discloses a card in which hue and brightness are changed according to a visual angle by causing a scale-like masking pigment to absorb a coloring matter having a diameter smaller than that of the pigment and uniformly dispersing and arranging the scale-like masking pigment in a resin layer of the card. Japanese Patent No. 3342056 (Patent Document 3) proposes a hologram in which a polarization control layer is provided.

### SUMMARY OF THE INVENTION

However, it is difficult to directly apply the card disclosed in Patent Document 2 to a volume hologram because, if the scale-like pigment absorbing the coloring matter is dispersed and arranged in a hologram recording layer, the scale-like pigment prevents the contact print from an original master. The hologram disclosed in Patent Document 3 may be unable to realize a remarkable effect of manifesting a latent image, although the hologram has an effect of deteriorating overall efficiency of hologram images to be copied.

Therefore, it is desirable to provide a hologram recording medium that prevents counterfeit through unauthorized copying by making it possible to discriminate that a hologram copied in an unauthorized manner using a hologram sticker as a master is obviously an unauthorized copy.

According to an embodiment of the present invention, there is provided a hologram recording medium including: a hologram recording layer; and a light scattering layer, wherein a material having a reflection characteristic different from that of a main material forming the light scattering layer is arranged in the light scattering layer.

When the hologram recording layer and the light scattering layer are separated, the hologram recording layer and the light scattering layer are cut off involving cohesive failure of the hologram recording layer.

Diffuse reflection as used in this specification means diffusive reflection of light excluding mirror reflection and is specified in JIS Z 8741. The mirror reflection means reflection of light conforming to the rule of reflection like reflection on the surface of a mirror and is specified in JIS Z 8741. Schematic diagrams of the diffuse reflection and the mirror reflection are respectively shown in FIGS. 20A and 20B. A conceptual diagram of a specular glossmeter specified in JIS Z 8741 is shown in FIG. 21. A component of the diffuse reflection can be measured by using such a specular glossmeter. In this specification, a regular reflection direction means the direction of light reflected in the direction of a reflection angle α2 same as an incident angle α1 of incident light as shown in FIG. 20B.

The hologram recording medium according to the embodiment of the present invention includes the layer in which the material having the reflection characteristic different from that of the main material forming the light scattering layer is arranged. The material having the reflection characteristic different from that of the main material forming the light scattering layer can be easily observed by an observer of a hologram. When copying by the contact print is performed using the hologram recording medium according to the embodiment of the present invention as a master, an image of the reflection material is recorded in a color same as a recording color of the hologram on a recording medium copied in an unauthorized manner. Therefore, the hologram recorded on the recording medium copied in an unauthorized manner is clearly different from hologram images observed from the hologram recording medium according to the embodiment of the present invention.

According to the embodiment of the present invention, when unauthorized copying is performed using the hologram recording medium as a master, hologram images of the material having the reflection characteristic different from that of the main material forming the light scattering layer are recorded in a hologram after the copying. Therefore, it is possible to easily discriminate that the copied hologram is copied in an unauthorized manner and it is possible to show an effect of counterfeit prevention.

### BRIEF DESCRIPTION OF THE DRAWINGS

FIG. 1 is a schematic diagram of a configuration example of a holographic stereogram creating system that can be applied to the present invention;

FIG. 2 is a schematic diagram used for explanation of an example of image processing during holographic stereogram creation;

FIGS. 3A and 3B are schematic diagrams of an example of an optical system of a holographic stereogram printer apparatus;

FIGS. 4A and 4B are schematic diagrams of another example of the optical system of the holographic stereogram printer apparatus;

FIG. 5 is a sectional view of an example of a hologram recording medium;

FIGS. 6A to 6C are schematic diagrams of an exposing process for a photo-polymerization type photopolymer;

FIG. 7 is a schematic diagram of a configuration example of a recording medium feeding mechanism;

FIG. 8 is a flowchart for explaining an example of exposure processing;

FIG. 9 is a sectional schematic view of a structure example of a laminated structure of a hologram recording medium according to a first embodiment of the present invention;

FIGS. 10A to 10C are schematic diagrams for explaining a function of preventing counterfeit of the hologram recording medium according to the embodiment;

FIG. 11 is a sectional schematic view of an example of a hologram recording medium including a black intermediate base material layer;

FIG. 12 is a sectional schematic view of an example in which diffuse reflection members are arranged in an adherend;

FIG. 13 is a sectional schematic view of a structure example of a laminated structure of a hologram recording medium according to a second embodiment of the present invention;

FIG. 14 is a sectional schematic view of a structure example of a first modification of the second embodiment;

FIG. 15 is a sectional schematic view of a structure example of a second modification of the second embodiment;

FIG. 16 is a sectional schematic view of a structure example of the second modification of the second embodiment;

FIG. 17 is a schematic diagram used for explanation of contact print;

FIG. 18 is a schematic diagram of an example of a manufacturing apparatus for a hologram recording medium;

FIGS. 19A to 19C are sectional schematic views of an example of layer structures in manufacturing steps for a hologram recording medium;

FIGS. 20A and 20B are schematic diagrams used for explanation of diffuse reflection and mirror reflection; and

FIG. 21 is a conceptual diagram of a specular glossmeter specified in JIS Z 8741.

### DESCRIPTION OF THE PREFERRED EMBODIMENTS

Best modes for carrying out the present invention (hereinafter referred to as embodiments) are explained below in the following order.

<1. Creation of an original master>

“Holographic stereogram creating system”

“Holographic stereogram printer apparatus”

“Example of a hologram recording medium”

“Recording medium feeding mechanism”

“Operation of the holographic stereogram creating system”

### <2. First Embodiment>

“Laminated structure of a hologram recording medium”

“Diffuse reflection members”

“Function of counterfeit prevention”

“Modification of the first embodiment”

### <3. Second Embodiment>

“Modification of the second embodiment”

### <4. Modifications>

The embodiments explained below are preferred schematic example of the present invention and involve technically preferred various limitations. However, the scope of the present invention is not limited by the embodiments unless it is specifically described below that the present invention is limited.

### 1. Creation of an Original Master

### “Holographic Stereogram Creating System”

Prior to the explanation of a hologram recording medium according to the present invention, creation of an original master is explained. In general, it is possible to synthesize, using two-dimensional images of a subject viewed from different viewpoints as original images, a hologram for reproducing a three-dimensional image. The hologram synthesized in this way is referred to as holographic stereogram. The holographic stereogram is created by, for example sequentially recording original images, which are a large number of images obtained by sequentially photographing a subject from different observation points, as strip-like element holograms on one hologram recording medium.

A process for creating a holographic stereogram as an original master schematically includes a content creating step including processing such as acquisition of images and editing of the acquired images and a printing step for the holographic stereogram. The images are acquired by imaging or computer graphics. Each of plural images obtained in the image editing step is converted into a strip-like image by, for example, a cylindrical lens. Interference fringes of object light of the images and reference light are sequentially recorded on a hologram recording medium as strip-like element holograms, whereby a holographic stereogram as an original master is created.

First, a configuration example of a holographic stereogram creating system that creates a holographic stereogram is explained. An apparatus for forming a holographic stereogram, which is given parallax information in the horizontal direction, by recording strip-like plural element holograms on one recording medium is explained below.

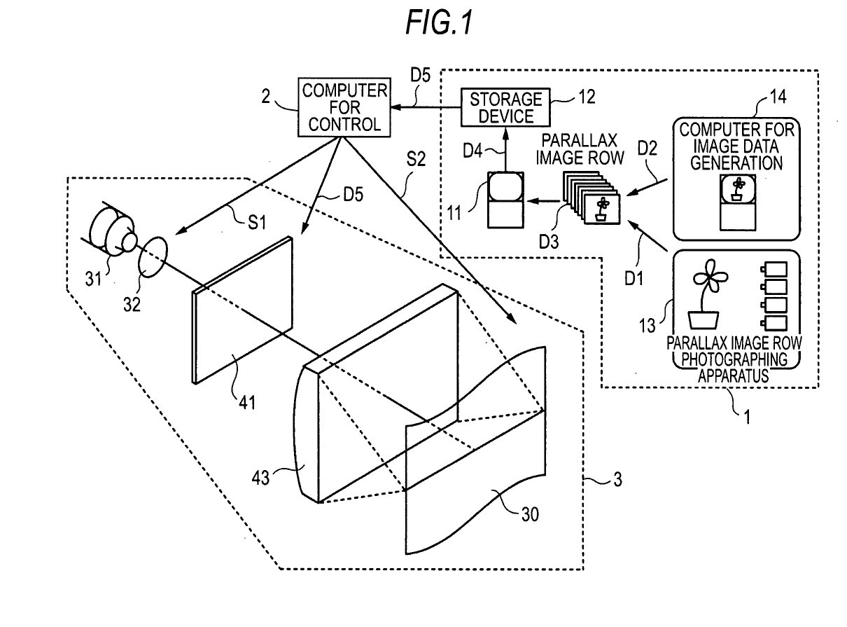

The holographic stereogram creating system is a system that creates a so-called one-step holographic stereogram, i.e., directly uses, as a holographic stereogram, a hologram recording medium on which interference fringes of object light and reference light are recorded. As shown in FIG. 1, the holographic stereogram creating system includes a data processing unit 1 that performs processing of image data as a recording target, a computer for control 2 that performs control of the entire system, and a holographic stereogram printer apparatus 3 having an optical system for holographic stereogram creation.

The data processing unit 1 generates a parallax image row D3 on the basis of plural image data D1 including parallax information supplied from a parallax image row photographing apparatus 13 including a multi-lens camera and a mobile camera. The data processing unit 1 generates the parallax image row D3 on the basis of, as other data, plural image data D2 including parallax information generated by a computer for image data generation 14.

The plural image data D1 including the parallax information supplied from the parallax image row photographing apparatus 13 is image data for plural images. Such image data is obtained by photographing an actual object from different plural observation points in the horizontal direction through, for example, simultaneous photographing by the multi-lens camera or continuous photographing by the mobile camera.

The plural image data D2 including the parallax information is generated by the computer for image data generation 14. The image data D2 is image data of, for example, plural CAD (Computer Aided Design) images or CG (Computer Graphics) images sequentially created by giving parallax thereto in the horizontal direction.

The data processing unit 1 applies, using a computer for image processing 11, predetermined image processing for holographic stereogram to the parallax image row D3. The data processing unit 1 records image data D4 subjected to the predetermined image processing in a storage device 12 such as a memory or a hard disk.

When images are recorded on the hologram recording medium, the data processing unit 1 reads out, in order for each image, data from the image data D4 recorded in the storage device 12 and sends read-out image data D5 to the computer for control 2.

On the other hand, the computer for control 2 drives the holographic stereogram printer apparatus 3. Images based on the image data D5 supplied from the data processing unit 1 are sequentially recorded in a hologram recording medium 30 set in the holographic stereogram printer apparatus 3 as strip-like element holograms.

At this point, as explained later, the computer for control 2 performs control of a shutter 32, a display device 41, a recording medium feeding mechanism, and the like provided in the holographic stereogram printer apparatus 3. Specifically, the computer for control 2 sends a control signal S1 to the shutter 32 and controls opening and closing of the shutter 32. The computer for control 2 supplies the image data D5 to the display device 41 and causes the display device 41 to display the images based on the image data D5. Further, the computer for control 2 sends the control signal S2 to the recording medium feeding mechanism and controls a feeding operation for the hologram recording medium 30 by the recording medium feeding mechanism.

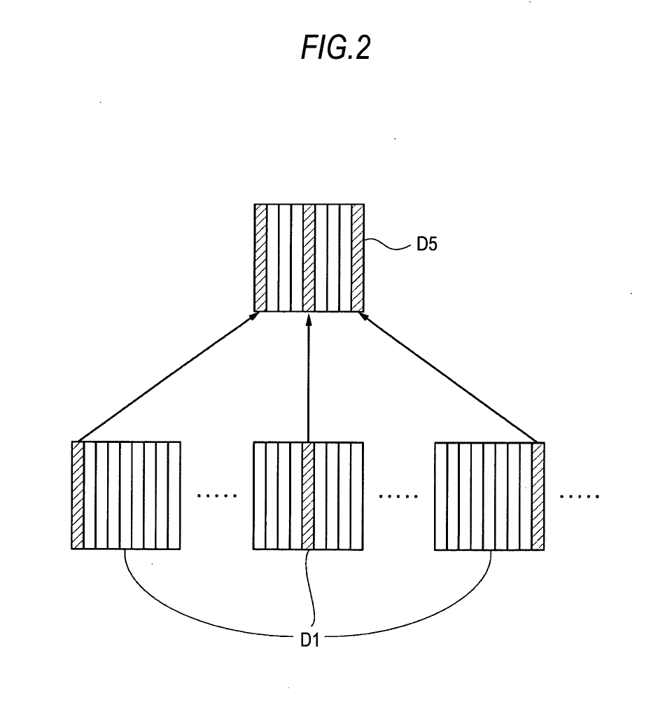

As shown in FIG. 2, image processing is processing for dividing each of the plural image data D1 including the parallax information in a slit shape in a parallax direction, i.e., the lateral (width) direction and collecting slices after the division to reform an image D5 after the processing. This image D5 is displayed on the display device 41.

### “Holographic Stereogram Printer Apparatus”

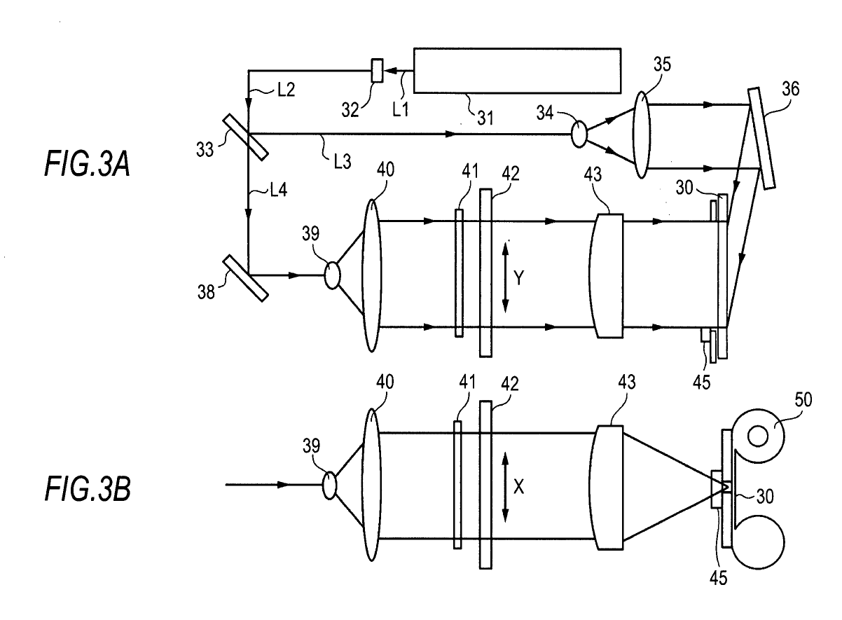

The optical system of the holographic stereogram printer apparatus 3 is explained more in detail with reference to FIGS. 3A and 3B. FIG. 3A is a diagram of the optical system of the entire holographic stereogram printer apparatus 3 viewed from above. FIG. 3B is a diagram of the optical system of the entire holographic stereogram printer apparatus 3 viewed from a side.

The holographic stereogram printer apparatus 3 includes, as shown in FIGS. 3A and 3B, a laser beam source 31 that emits a laser beam having predetermined wavelength, the shutter 32, a mirror 38, and a half mirror 33 arranged on the optical axis of a laser beam L1 emitted from the laser beam source 31. As the laser beam source 31, for example, a laser beam source that emits a laser beam having wavelength of about 532 nm is used.

The shutter 32 is controlled by the computer for control 2 to be closed when the hologram recording medium 30 is not exposed to light and opened when the hologram recording medium 30 is exposed to light. The half mirror 33 is a mirror for separating a laser beam L2 passed through the shutter 32 into reference light and object light. Light L3 reflected by the half mirror 33 changes to the reference light and light L4 transmitted through the half mirror 33 changes to the object light.

In this optical system, the optical path length of the reference light reflected by the half mirror 33 and made incident on the hologram recording medium 30 and the optical path length of the object light transmitted through the half mirror 33 and made incident on the hologram recording medium 30 are set to substantially the same lengths. Consequently, coherence of the reference light and the object light is increased. This makes it possible to create a holographic stereogram from which a clearer reproduced image can be obtained.

On the optical path of the light L3 reflected by the half mirror 33, a cylindrical lens 34, a collimator lens 35 for changing the reference light into parallel rays, and a reflection mirror 36 that reflects the parallel rays from the collimator lens 35 are arranged in this order as optical systems for the reference light.

First, the light reflected by the half mirror 33 is changed to a diverging ray by the cylindrical lens 34. Subsequently, the diverging ray is changed to parallel rays by the collimator lens 35. Thereafter, the parallel rays are reflected by the reflection mirror 36 and made incident on the rear surface side of the hologram recording medium 30.

On the other hand, optical systems for the object light is provided on the optical axis of the light L4 transmitted through the half mirror 33. As the optical systems, a reflection mirror 38 that reflects the transmitted light from the half mirror 33, a spatial filter 39 obtained by combining a convex lens and a pinhole, and a collimator lens 40 for changing the object light into parallel rays are used. The display device 41 that displays an image as a recording target and a one-dimensional diffuser 42 that diffuses the light transmitted through the display device 41 in the width direction of element holograms are used. Further, a cylindrical lens 43 that condenses the object light transmitted through the one-dimensional diffuser 42 on the hologram recording medium 30 and an optical function plate 45 having a one-dimensional diffusing function are used.

The cylindrical lens 43 condenses the object light in a parallax direction (the lateral direction of the element holograms or, during an observation, the horizontal direction).

The optical function plate 45 is a plate that one-dimensionally diffuses the condensed object light in the longitudinal direction of the strip-like element holograms and is used to deal with movement of an eye point in the longitudinal direction. The optical function plate 45 is a micro-structure. For example, a lenticular lens having a fine pitch can be used as the optical function plate 45.

The light L4 transmitted through the half mirror 33 is changed to a diverging ray from a point light source by the spatial filter 39 after being reflected by the reflection mirror 38. Subsequently, the diverging ray is changed to parallel rays by the collimator lens 40 and, thereafter, made incident on the display device 41. In this embodiment, an object lens with a magnification of 20 and a pinhole having a diameter of 20 μm (micrometers) are used in the spatial filter 39. The focal length of the collimator lens 40 is set to 100 nm.

The display device 41 is, for example, an image display device of a projection type including a liquid crystal display. The display device 41 is controlled by the computer for control 2 and displays an image based on the image data D5 sent from the computer for control 2. In this example, a monochrome liquid crystal panel having the number of pixels 480×1068 and size of 16.8 mm×29.9 mm is used.

The light transmitted through the display device 41 changes to light modulated by the image displayed on the display device 41 and is diffused by the one-dimensional diffuser 42. The one-dimensional diffuser 42 only has to be arranged near the display device 41 and is arranged immediately in front of or immediately behind the display device 41. In this example, the one-dimensional diffuser 42 is arranged immediately behind the display device 41.

The one-dimensional diffuser 42 slightly diffuses the transmitted light from the display device 41 in the width direction of the element holograms to thereby diffuse the light in the element holograms. Consequently, the one-dimensional diffuser 42 contributes to improvement of the quality of a holographic stereogram to be created.

A Diffuser moving section (not shown in the figure) is provided in the diffuser 42. The diffuser moving section moves the diffuser 42 at random every time each of the element holograms is formed to change the positions of the diffuser 42 for each of the element holograms. This makes it possible to reduce noise located at the infinity when a hologram is observed.

As the diffuser plate moving section for movement of the diffuser 42, for example, a moving mechanism that moves the diffuser 42 by a fixed amount at a time with a mechanical method such as a stepping motor can be adopted. A moving direction of the diffuser 42 by this configuration may be the width direction of the element holograms (an arrow X direction in FIG. 3B) or may be a direction orthogonal to the width direction. The moving direction may be a combination of the width direction and the arrow X direction. The diffuser 42 may move completely at random or can reciprocatingly move.

The inside of the width of the element holograms is uniformly exposed to light by arranging the diffuser 42 in this way. Therefore, the quality of a hologram to be obtained is improved. However, when it is attempted to realize the uniform exposure, it is necessary to intensify diffusion of the diffuser 42 to a certain extent. The object light diffused by the diffuser 42 spreads on the hologram recording medium 30 and exposes a range wider than the original width of the element holograms to light.

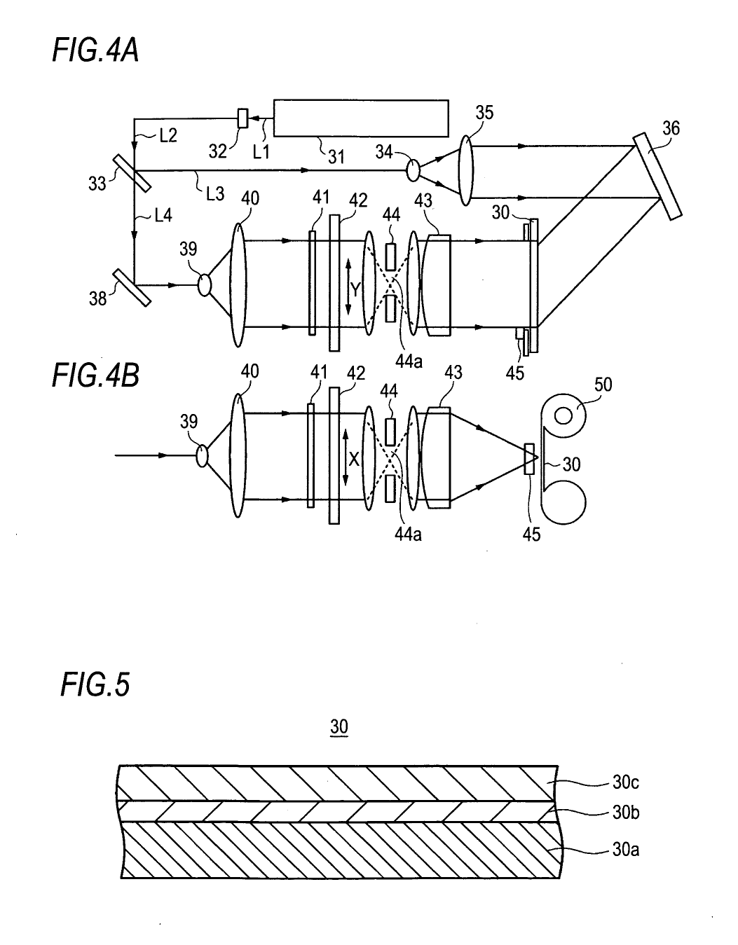

Therefore, as shown in FIGS. 4A and 4B, a mask 44 is arranged in the optical path and an image of the mask 44 is projected on a recording material to thereby expose the element holograms to light at proper width. In other words, uniform and proper exposure width is obtained through the diffusion by the diffuser 42 and blocking of unnecessary light by the mask 44. As shown in FIGS. 4A and 4B, the position of the mask 44 may be set between the diffuser 42 and the cylindrical lens 43 or may be set near the hologram recording medium 30.

Specifically, the transmitted light from the display device 41 is focused on the hologram recording medium 30 by the cylindrical lens 43 after being transmitted through the diffuser 42 and diffused in the width direction of the element holograms. At this point, the object light is not condensed at one point but spreads to a certain range because of the influence of the diffuser 42.

As shown in FIGS. 4A and 4B, only a predetermined range in the center of the spread focused light is transmitted through an opening 44a of the mask 44 and made incident on the hologram recording medium 30 as object light. The shape of the object light is strip-like.

As explained above, the optical function plate 45 is arranged as a second diffuser. The object light is one-dimensionally diffused in the longitudinal direction of the strip-like element holograms and irradiated on the hologram recording medium 30. This makes it possible to widen an angular field of view in the longitudinal direction (the vertical direction) of a reflection-type hologram.

In a normal holographic stereogram having parallax only in the horizontal direction, the optical function plate 45 is finally imparted with an optical function angle substantially equal to an angular field of view in the up-down direction of the reflection-type hologram.

The holographic stereogram printer apparatus 3 includes a recording medium feeding mechanism 50 that can intermittently feed the hologram recording medium 30 by a distance equivalent to one element hologram under the control by the computer for control 2. As explained later, the recording medium feeding mechanism 50 is configured to be capable of intermittently feed a film-like hologram recording medium on the basis of a control signal from the computer for control 2. When a holographic stereogram is created by the holographic stereogram printer apparatus 3, images based on image data of a parallax image row are sequentially recorded as strip-like element holograms on the hologram recording medium 30 set in the recording medium feeding mechanism 50.

### “Example of the Hologram Recording Medium”

The hologram recording medium 30 used in the holographic stereogram creating system is explained in detail below. In the hologram recording medium 30, a photopolymer layer 30b including photo-polymerization type photopolymer is formed on a film base material 30a formed in a tape shape. The hologram recording medium 30 is a recording medium of a so-called film application type formed by further bonding a cover sheet 30c on the photopolymer layer 30b.

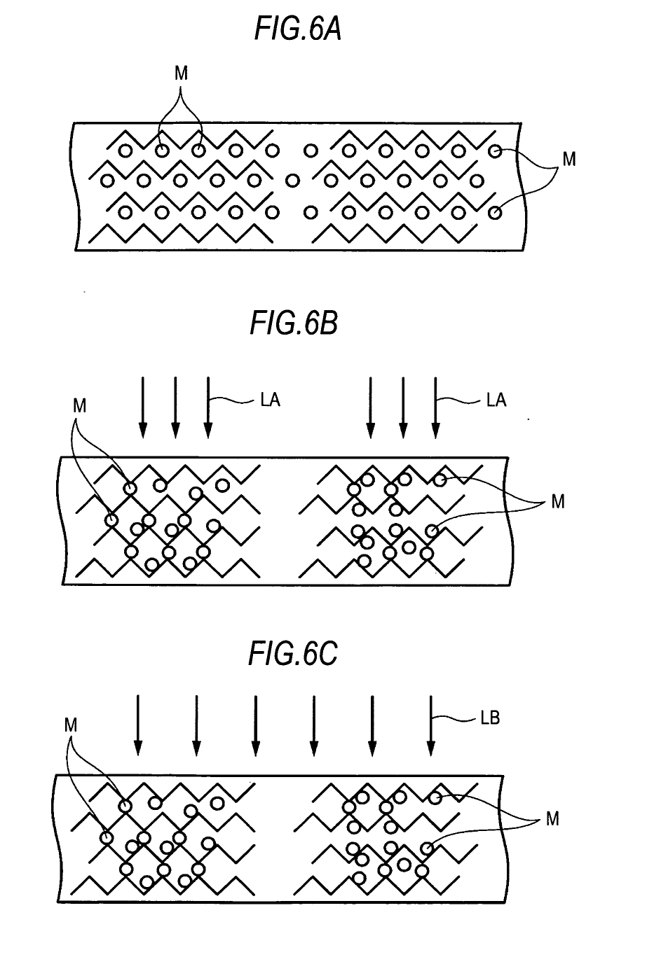

In an initial state of the photo-polymerization photopolymer, as shown in FIG. 6A, monomers M are uniformly dispersed in a matrix polymer. On the other hand, as shown in FIG. 6B, when light LA having power of about 10 to 400 mJ/cm² is irradiated, the monomers M are polymerized in exposed portions. As the monomers M are polymerized, the monomers M move from the periphery and the density of the monomers M changes depending on places, whereby refractive index modulation occurs. Thereafter, as shown in FIG. 6C, the polymerization of the monomers M is completed by irradiating an ultraviolet ray or visible light LB having power of about 1000 mJ/cm² on the entire surface of the photo-polymerization type photopolymer. In this way, in the photo-polymerization type photopolymer, since a refractive index changes according to incident light, interference fringes caused by interference of reference light and object light can be recorded as the change in the refractive index.

The hologram recording medium 30 including such a photo-polymerization photopolymer does not need to be subjected to special development processing after exposure. Therefore, it is possible to simplify the configuration of the holographic stereogram printer apparatus 3 according to this embodiment that uses the hologram recording medium 30 including the photo-polymerization photopolymer in a photosensitive portion.

### “Recording Medium Feeding Mechanism”

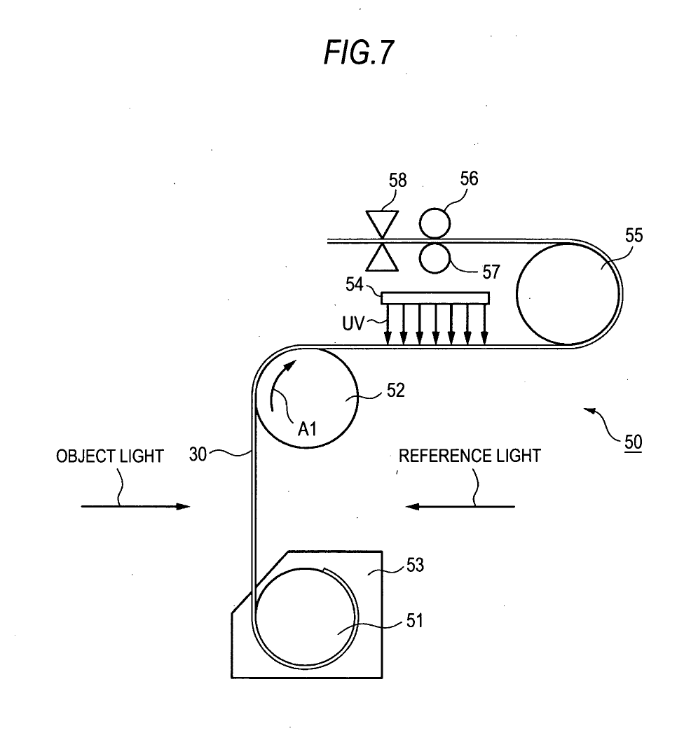

The recording medium feeding mechanism 50 is explained in detail. FIG. 7 is an enlarged diagram of the section of the recording medium feeding mechanism 50 of the holographic stereogram printer apparatus 3.

As shown in FIG. 7, the recording medium feeding mechanism 50 includes a roller 51 and a roller for intermittent feed 52. The hologram recording medium 30 is stored in a film cartridge 53 while being wound around the roller 51. The recording medium feeding mechanism 50 axially supports the roller 51 in the film cartridge 53, which is inserted in a predetermined position, to freely rotate with predetermined torque. The hologram recording medium 30 drawn out from the film cartridge 53 can be held by the roller 51 and the roller for intermittent feed 52. At this point, since the principal plane of the hologram recording medium 30 is set substantially perpendicular to object light between the roller 51 and the roller for intermittent feed 52, the recording medium feeding mechanism 50 holds the hologram recording medium 30. The roller 51 and the roller for intermittent feed 52 are urged by a torsion coil spring in a direction in which the roller 51 and the roller for intermittent feed 52 are estranged from each other. Consequently, predetermined tension is applied to the hologram recording medium 30 loaded to be laid over between the roller 51 and the roller for intermittent feed 52.

The roller for intermittent feed 52 of the recording medium feeding mechanism 50 is connected to a not-shown stepping motor and configured to be capable of freely rotating in a direction indicated by an arrow A1 in the figure on the basis of the torque from the stepping motor. The stepping motor sequentially rotates, on the basis of a control signal S2 supplied from the computer for control 2, the roller for intermittent feed 52 by a predetermined angle corresponding to one element hologram every time exposure for one image ends. Consequently, the hologram recording medium 30 is fed by a distance equivalent to one element hologram in every exposure for one image.

At a post stage of the roller for intermittent feed 52 in a route of the hologram recording medium 30, an ultraviolet lamp 54 is disposed along the route. The ultraviolet lamp 54 is a lamp for completing the polymerization of the monomers M of the hologram recording medium 30 exposed to light. The ultraviolet lamp 54 is configured to be capable of irradiating an ultraviolet ray UV having predetermined power on the hologram recording medium 30 fed by the roller for intermittent feed 52.

Further, at a post stage of the ultraviolet lamp 54 in the route of the hologram recording medium 30, a heat roller 55 axially supported to freely rotate, a pair of feed rollers for discharge 56 and 57, and a cutter 58 are disposed one after another.

The feed rollers for discharge 56 and 57 are configured to feed the hologram recording medium 30 such that the cover sheet 30c side of the hologram recording medium 30 is wound around the circumferential side of the heat roller 55 over about a half circumference in a closely attached state. The feed rollers for discharge 56 and 57 are connected to a not-shown stepping motor and configured to be capable of rotating on the basis of the torque from the stepping motor. The stepping motor is rotated on the basis of the control signal S2 supplied from the computer for control 2. Specifically, the feed rollers for discharge 56 and 57 are sequentially rotate in synchronization with the rotation of the roller for intermittent feed 52 by the predetermined angle corresponding to one element hologram every time exposure for one image ends. Consequently, hologram recording medium 30 is surely fed while being closely attached to the circumferential side of the heat roller 55 without slacking between the roller for intermittent feed 52 and the feed rollers for discharge 56 and 57. The heat roller 55 includes a heat generating section such as a heater on the inside thereof and is configured such that the circumferential side of the heat roller 55 can keep temperature of about 120° C. with the heat generating section. The heat roller 55 heats the photopolymer layer 30b of the fed hologram recording medium 30 via the cover sheet 30c. A refractive index modulation degree of the photopolymer layer 30b is increased by this heating to fix a recording image on the hologram recording medium 30. Therefore, the outer diameter of the heat roller 55 is selected such that time enough for fixing the recording image elapses from the start of contact of the hologram recording medium 30 with the circumferential side to separation from the circumferential side.

The cutter 58 includes a not-shown cutter driving mechanism and is configured to be capable of cutting the fed hologram recording medium 30 by driving the cutter driving mechanism. The cutter driving mechanism drives the cutter 58. Specifically, after all images of image data of a parallax image row are recorded on the recording medium 30, the cutter 58 is driven at a stage when all sections in which the images are recorded of the recorded medium 30 are discharged. Consequently, the sections in which the image data is recorded are separated from the other sections and discharged to the outside as one holographic stereogram.

### “Operation of the Holographic Stereogram Creating System”

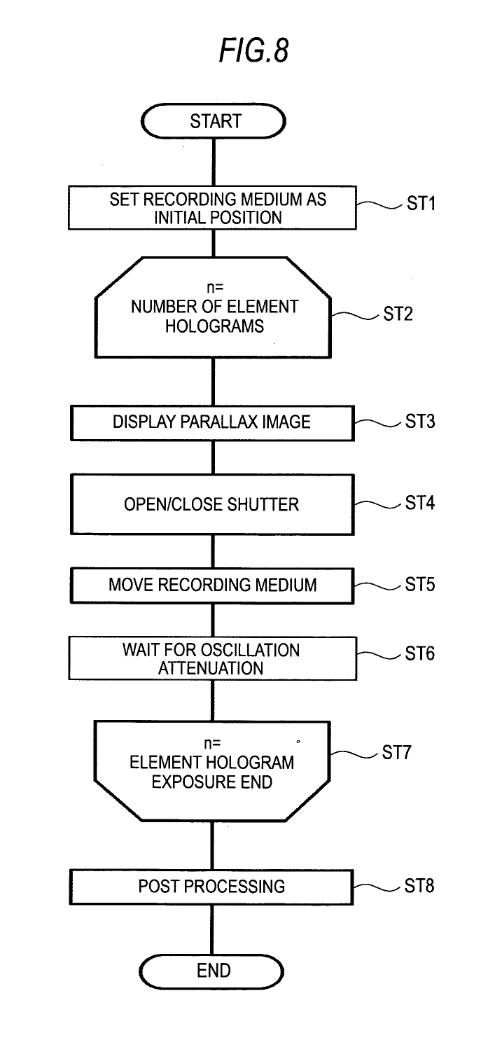

An operation in creating a holographic stereogram under the control by the computer for control 2 in the holographic stereogram creating system having the configuration explained above is explained below with reference to a flowchart of FIG. 8.

In step ST1, the hologram recording medium 30 is set as an initial position. Step ST2 is a step at a start end of a loop. Step ST7 is a step at a terminal end of the loop. Processing for one element hologram ends every time a series of processing in steps ST3 to ST6 is executed. Steps ST3 to ST6 are repeated until the processing for the number (n) of all element holograms ends.

In step ST3, the computer for control 2 drives the display device 41 on the basis of the image data D5 supplied from the data processing unit 1 and causes the display device 41 to display an image. In step ST4, the computer for control 2 sends the control signal S1 to the shutter 32 to open the shutter 32 for a predetermined time and exposes the hologram recording medium 30 to light. At this point, the light L3 reflected by the half mirror 33 in the laser beam L2 emitted from the laser beam source 31 and transmitted through the shutter 32 is made incident on the hologram recording medium 30 as reference light. At the same time, the light L4 transmitted through the half mirror 33 changes to projected light on which the image displayed on the display device 41 is projected. The projected light is made incident on the hologram recording medium 30 as object light. Consequently, one image displayed on the display device 41 is recorded on the hologram recording medium 30 as a strip-like element hologram.

When the recording of the one image ends, in step ST5, the computer for control 2 sends the control signal S2 to the stepping motor for driving the roller for intermittent feed 52 and the stepping motor for driving the feed rollers for discharge 56 and 57. By driving the stepping motors, the computer for control 2 causes the roller for intermittent feed 52 and the feed rollers for discharge 56 and 57 to feed the hologram recording medium 30 by a distance equivalent to one element hologram. After the hologram recording medium 30 is fed, time for waiting for oscillation to be attenuated is provided (step ST6).

Subsequently, the processing returns to step ST3. The computer for control 2 drives the display device 41 on the basis of the next image data D5 supplied from the data processing unit 1 and causes the display device 41 to display the next image. Thereafter, the computer for control 2 sequentially repeats operations (ST4, ST5, and ST6) same as the above, whereby images based on the image data D5 supplied from the data processing unit 1 are sequentially recorded on the hologram recording medium 30 as strip-like element holograms.

In other words, in the holographic stereogram creating system, images based on image data recorded in the storage device 12 are sequentially displayed on the display device 41. At the same time, the shutter 32 is opened for each of the images and the images are sequentially recorded on the hologram recording medium 30 respectively as strip-like element holograms. At this point, since the hologram recording medium 30 is fed by a distance equivalent to one element hologram for each of the images, the element holograms are continuously arranged side by side in the horizontal direction (the lateral direction) during an observation. Consequently, images of parallax information in the horizontal direction are recorded on the hologram recording medium 30 as plural element holograms continuing in the lateral direction. In this way, a holographic stereogram having parallax in the horizontal direction is obtained.

The steps up to the exposure process are explained above. Thereafter, post processing (step ST8) is performed according to necessity and the printing step is completed. In the case of a photopolymer for which ultraviolet ray irradiation and heating are necessary, the apparatus configuration shown in FIG. 7 can be adopted. Specifically, the ultraviolet ray UV is irradiated from the ultraviolet lamp 54. Consequently, the polymerization of the monomers M is completed. Subsequently, the hologram recording medium 30 is heated by the heat roller 55, whereby fixing of the recording image is performed.

When all the sections in which the images are recorded are discharged to the outside, the computer for control 2 supplies the control signal S2 to the cutter driving mechanism and drives the cutter driving mechanism. Consequently, the sections in which the images are recorded of the hologram recording medium 30 are cut off by the cutter 58 and discharged to the outside as one holographic stereogram.

According to the steps explained above, a holographic stereogram having parallax in the horizontal direction serving as an original master is completed.

### 2. First Embodiment

A structure example of a hologram recording medium according to a first embodiment of the present invention is explained below. The hologram recording medium according to the first embodiment is a hologram copied from an original master and is a hologram for which genuineness determination is easy. There is an effect that it is seen that a hologram copied in an unauthorized manner using the hologram recording medium according to the first embodiment as a master is different from a genuine hologram. Further, means for preventing unauthorized copying of the hologram recording medium according to the first embodiment does not obstruct an observation of original hologram images.

### “Laminated Structure of a Hologram Recording Medium”

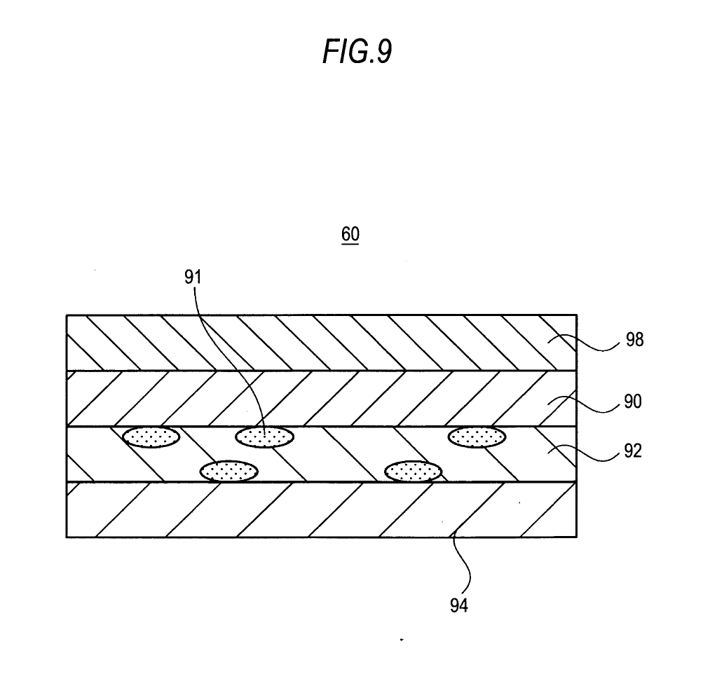

FIG. 9 is a sectional schematic diagram of a structure example of a laminated structure of a hologram recording medium 60 according to the first embodiment. In the structure example shown in FIG. 9, a protective layer 98, a hologram recording layer 90, an adhesive layer (also referred to as bonding layer) 92 as a light scattering layer, and a release layer 94 are laminated in order from an observer side of a hologram (the upper side in FIG. 9). Diffuse reflection members 91 are arranged in the adhesive layer 92. The layers are explained below.

The hologram recording layer 90 is, for example, a layer having the photopolymer layer including the photo-polymerization photopolymer explained above. In order to maintain the shape of the photopolymer layer, the hologram recording layer 90 may include a layer equivalent to the film base material 30a. In the contact print, interference fringes of an incident laser beam and diffractive light from an original master are recorded in the hologram recording layer 90.

The protective layer 98 is provided for prevention of scratches, charging prevention, and stabilization of a hologram shape. The protective layer 98 is a layer corresponding to the cover sheet 30c. In particular, when the original master is fed through various rollers in a step for copying the original master, it is desirable that the protective layer 98 is formed on the hologram recording layer 90.

As a material forming the protective layer 98, for example, a polyethylene terephthalate (PET) film, a polyethylene film, a polypropylene film, a polycarbonate film, a polyvinyl chloride film, an acrylic film, a poly-cellulose acetate film, a cellulose acetate butyrate film, a tri-cellulose acetate film, a polyvinyl alcohol film, or a polymethyl methacrylate film can be used. The thickness of the protective layer 98 is desirably equal to or larger than 0.001 mm and equal to or smaller than 10 mm and more desirably equal to or larger than 0.01 mm and equal to or smaller than 0.1 mm.

The adhesive layer 92 is provided in order to bond the hologram recording medium 60, in which image information of the original master is recorded by the contact print, to an adherend. Examples of a material forming the adhesive layer 92 include acrylic resin, acrylic ester resin, or a copolymer of acrylic resin and acrylic ester resin, a styrene-butadiene copolymer, natural rubber, casein, gelatin, rosin ester, terpene resin, phenolic resin, styrene resin, chroman indene resin, polyvinyl ether, and silicone resin. Examples of the material also include an alpha-cyanoacrylate adhesive, a silicone adhesive, a maleimide adhesive, a styrol adhesive, a polyolefin adhesive, a resorcinol adhesive, and a polyvinyl ether adhesive. An adhesive layer formed of any of these materials is desirably applied and formed in thickness equal to or larger than 4 μm and equal to or smaller than 300 μm. Thermoplastic hot-melt adhesives of polyamide resin, polyolefin resin, polyester, modified olefin, reacting urethane, and an ethylene-vinyl acetate copolymer may be used. In this case, the adhesive layer 92 can be formed as a thin film of a so-called transfer foil. These adhesives including the hot-melt adhesives are hereinafter collectively referred to as adhesive.

The diffuse reflection members 91 are arranged in the adhesive layer 92 and act as a light scattering layer. The diffuse reflection members 91 are, for example, metal powder or metal pieces having unevenness on the surface thereof. As explained later, the diffuse reflection members 91 are members arranged in order to diffuse and reflect light made incident on the hologram recording medium 60 according to the first embodiment when the hologram recording medium 60 is observed.

Bonding power of the adhesive layer 92 to the adherend is desirably set higher compared with self-binding power or breaking strength of the hologram recording layer 90. In other words, when the hologram recording layer 90 and the light scattering layer are separated, at least apart of the hologram recording layer 90 is desirably cut off involving cohesive failure. This is because, when it is attempted to separate the hologram recording layer 90 and the adhesive layer 92 to attempt the contact print with the diffuse reflection members 91 removed, the hologram recording layer 90 is destroyed earlier and unauthorized copying can be prevented. A state of such destruction depends on peeling speed. It is possible to measure whether the cohesive failure occurs by performing a 180° peeling test specified in JIS Z 0237. Measurement conditions for the measurement are as described below.

Measurement atmosphere: 23° C.±2° C., 50±5% RH

Test piece: 25 mm width

Bonding: Press contact by reciprocating movement of a 2 kg rubber roller

Bonding time: 60 minutes after bonding

Peeling angle: 180°

Peeling speed: 250 mm/min

The release layer 94 is a release film made of resin of PET or the like. By adopting such a structure, it is possible to easily bond the hologram recording medium 60 to the adherend via the adhesive layer 92 simply by peeling off the release layer 94. The hologram recording medium 60 can be used as a hologram sticker.

For example, the apparatus of the type disclosed in U.S. Pat. No. 5,798,850 can be applied to the manufacturing of the hologram recording medium 60 having the structure explained above. However, it goes without saying that an apparatus used for the manufacturing of the hologram recording medium 60 is not limited to this example.

### “Diffuse Reflection Members”

The diffuse reflection members 91 arranged in the adhesive layer 92 are explained in detail below. The diffuse reflection members 91 function to record, when further copying, i.e., unauthorized copying is attempted using the hologram recording medium 60 according to the first embodiment as a master, an image not present in an original master in a hologram copied in an unauthorized manner.

The structure example of the hologram recording medium 60 according to the first embodiment shown in FIG. 9 is an example in which an appropriate amount of metal powder having gloss is mixed in the adhesive layer 92 as the diffuse reflection members 91. For example, when the thickness of the adhesive layer 92 is set to about 30 μm, about 1500 pieces of metal powder having an average diameter of about 25 μm are mixed in the adhesive layer 92 per 1 cm³. In this case, when the hologram recording medium 60 in size of 15 mm square is observed, about ten mixed metal pieces in average are seen in a random position. The mixing of the metal powder in an amount of this degree does not deteriorate visibility of an overall hologram. However, the presence of the metal powder can be recognized if the metal powder is observed by a microscope or a magnifying glass. In this case, transparency of the adhesive layer 92 is set to such a degree as to not hinder the observation of the metal powder.

As the diffuse reflection members 91, for example, materials described below can be applied.

A. Metal color evaporated powder (metallic flake, example: “LG” manufactured by Daiya Kogyo Co., Ltd.)

B. Pearl pigment (peal gloss pigment, example: “ULTIMIKA (registered trademark)” manufactured by Nihonkoken Co., Ltd.)

C. Silver plating glass flake pigment, aluminum flake pigment, titanium dioxide pigment, or a mixture of the pigments

D. Chroma Flair pigment (a material color-shifted depending on a view angle, example: “MAZIORA (registered trademark)” manufactured by Nippon Paint Co., Ltd.)

E. Hologram piece (example: Daiya hologram AL type, HG-S 20AL (0.2 mm piece, 0.012 mm thick) manufactured by Daiya Kogyo Co., Ltd.)

F. Glitter (a pigment having a feel of lame, example: manufactured by Nihonkoken Co., Ltd.)

G. Fluorescent pigment (example: “SINLOIHI COLOR (registered trademark)” manufactured by Sinloihi Co., Ltd.)

H. Light accumulating pigment

I. Metal powder or metal foil such as gold powder, copper powder, zinc powder, gold foil, or zinc foil

J. Laminated member of different types of films such as a polyethylene terephthalate film and a polymethyl methacrylate film (example: “RAINBOW FLAKE” manufactured by Daiya Kogyo Co., Ltd.)

It goes without saying that members used as the diffuse reflection members 91 are not limited to the materials explained above. Several kinds of these materials may be laminated to form a multi-layer structure or may be mixed. As the material of the diffuse reflection members 91, a material that diffuses and reflects light enough for confirming the presence of the diffuse reflection members 91 when the hologram recording medium 60 is observed from the front is selected. This is for the purpose of printing, when the hologram recording medium 60 including the layer in which the diffuse reflection members 91 are arranged is copied in an unauthorized manner by the contact print, hologram images of the diffuse reflection members 91 on a hologram copied in an unauthorized manner. Mirror reflection members can also be used instead of the diffuse reflection members 91. In other words, spherical reflection members usually include a large number of mirror reflection components. However, any part of the spheres reflects light and the front of the reflection members shines. Even if most of incident light is reflected by a planer metal foil or the like, a hologram is formed in the direction of the reflected light. Even if an observation direction is limited to a regular reflection direction, it is possible to discriminate a genuine product and a counterfeit product by looking at a hologram of the regular reflection.

When the diffuse reflection members 91 having such a reflection characteristic are mixed, the observer of the hologram recording medium 60 can easily learn that means for preventing unauthorized copying is applied to the hologram recording medium 60. The presence of the hologram images of the diffuse reflection members 91 printed on the hologram copied in an unauthorized manner can also be confirmed in a direction different from the regular reflection direction.

All the sizes of the diffuse reflection members 91 are desirably equal to or larger than 0.01 mm and equal to or smaller than 3 mm. An upper limit of the sizes of the diffuse reflection members 91 is specified by the thickness of the adhesive layer 92. The presence of the diffuse reflection members 91 can be confirmed by a microscope or the like (the sizes of the diffuse reflection members 91 are larger than the order of the wavelength of visible light). Therefore, a lower limit of the sizes of the diffuse reflection members 91 is specified. If the diffuse reflection members 91 have a spherical shape, the sizes of the diffuse reflection members 91 are limited by the thickness of the adhesive layer 92. However, if the diffuse reflection members 91 are a foil, piece, or flake-like members, the diffuse reflection members 91 may have size of about 3 mm in a direction along the principal plane of the hologram recording medium 60 as long as the size is within the thickness of the adhesive layer 92 (desirably about thickness equal to or larger than 3 μm and equal to or smaller than 50 μm) in the thickness direction.

The content of the diffuse reflection members 91 is desirably equal to or higher than 0.01% and equal to or lower than 30% and more desirably equal to or higher than 0.1% and equal to or lower than 5% in terms of a volume ratio. If an amount of the mixed diffuse reflection members 91 is too small, it is difficult to attain the expected purpose of the counterfeit prevention. Conversely, if an amount of the mixed diffuse reflection members 91 is too large, visibility of a hologram itself is deteriorated or adhesive performance of the adhesive layer 92 is deteriorated.

### “Function of Counterfeit Prevention”

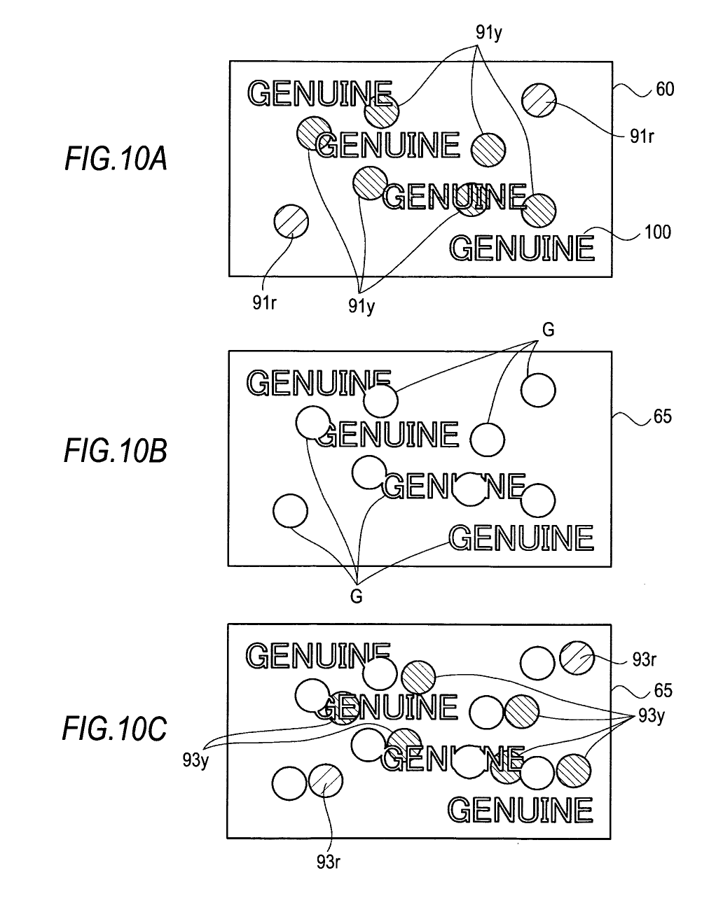

A function of counterfeit prevention for the hologram recording medium according to the first embodiment is explained below. FIG. 10A is a top view of the hologram recording medium 60 according to the first embodiment. It is assumed that image information 100 “GENUINE” contact-printed from an original master is recorded on the hologram recording medium 60. It is assumed that the image information 100 is recorded by a laser beam having wavelength corresponding to green. The image information 100 is recorded in the hologram recording layer 90. Diffuse reflection members 91y and 91r are arranged in the adhesive layer 92 on the inner side of the hologram recording layer 90 viewed from the observer. It is assumed that, when the hologram recording medium 60 is observed, a color sensed from the diffuse reflection members 91y is close to yellow and a color sensed from the diffuse reflection members 91r is close to red. In FIG. 10A, to facilitate understanding of the function of counterfeit prevention, the diffuse reflection members 91y and 91r are exaggeratedly shown in enlargement.

In general, an angular field of view in which a hologram can be observed is limited to a certain range. However, since the diffuse reflection members 91y and 91r have a large number of reflection components other than mirror reflection, the presence of the diffuse reflection members 91y and 91r can be sensed not only in a regular reflection direction of incident light but also in the range in which the hologram can be observed. Since the diffuse reflection members 91y and 91r are arranged in the adhesive layer 92 on the inner side of the hologram recording layer 90 viewed from the observer, the diffuse reflection members 91y and 91r do no obstacle an observation of the image information 100 recorded on the hologram. Therefore, the observer of the hologram recording medium can confirm the image information 100 “GENUINE” in green, yellowish reflection from the diffuse reflection members 91y, and reddish reflection from the diffuse reflection members 91r.

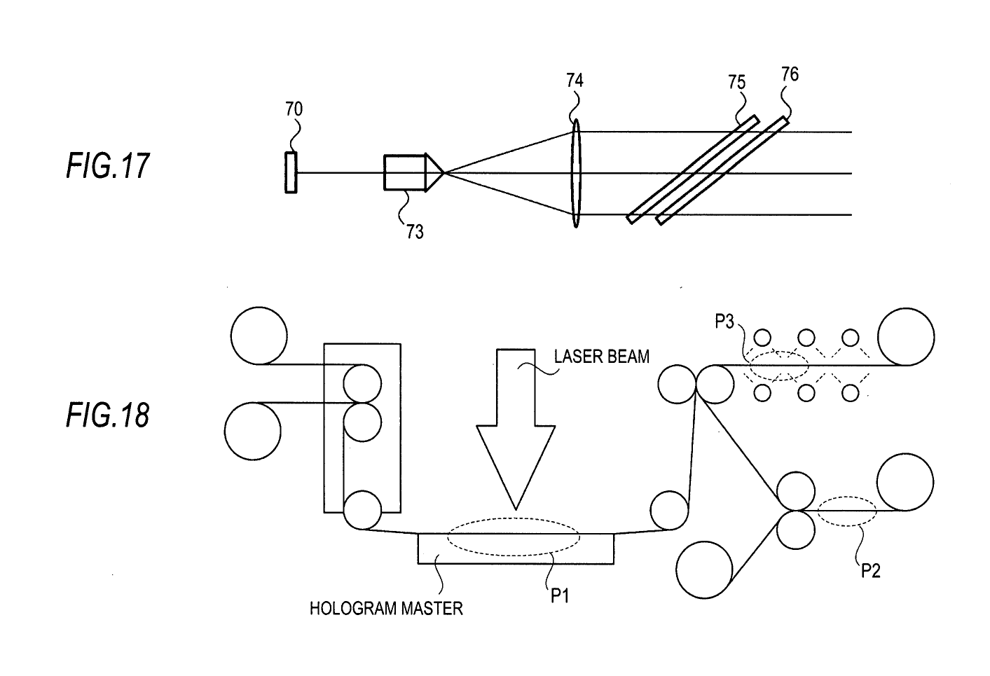

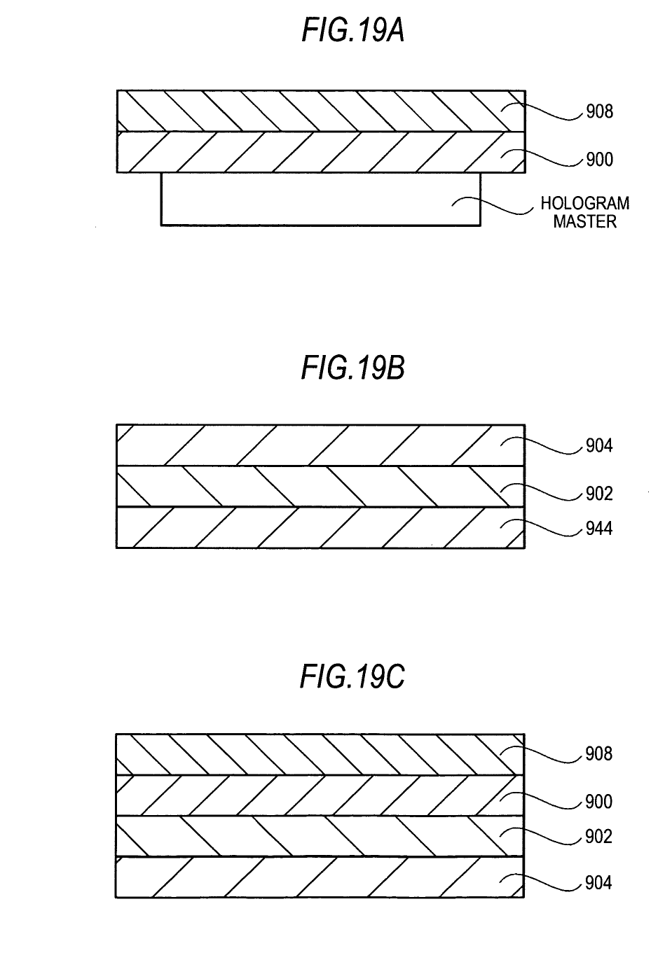

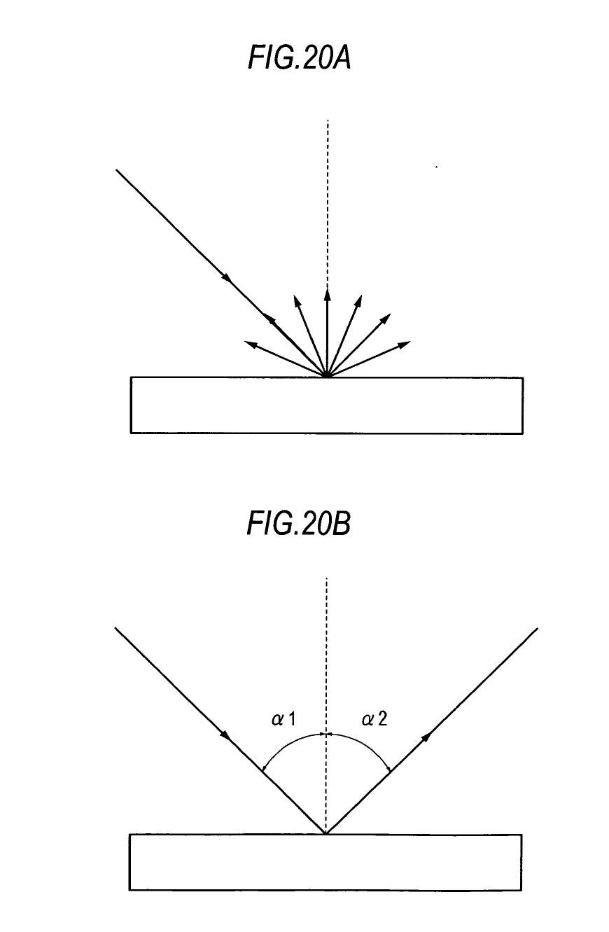

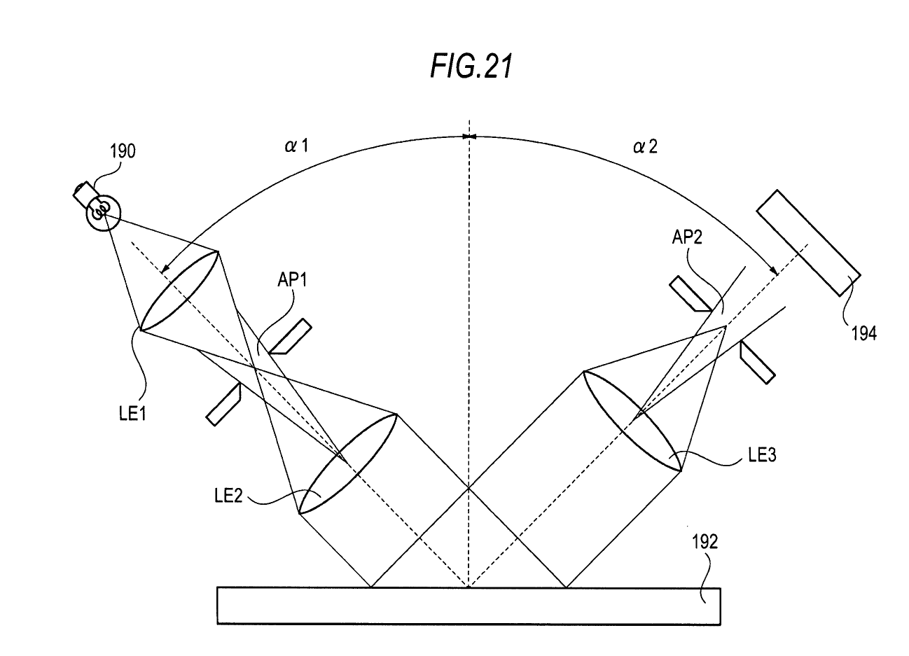

It is assumed that further copying, i.e., unauthorized copying by the contact print is attempted by a method shown in FIG. 17 using the hologram recording medium 60 as a master. For example, it is assumed that a hologram recording medium (hereinafter referred to as unauthorized recording medium as appropriate) is closely attached to the hologram recording medium 60 according to the first embodiment, which is the master, and a laser beam having wavelength same as that of the laser beam used for the contact print from the original master is made incident on principal planes of the hologram recording media from a direction at an angle of 45° with respect to the normal.

At this point, the laser beam made incident on the diffuse reflection members 91y and 91r is also diffused and reflected in directions other than a regular reflection direction. Therefore, not only the image information “GENUINE” but also hologram images of the diffuse reflection members 91y and 91r are recorded on the unauthorized recording medium. Further, the hologram images of the diffuse reflection members 91y and 91r recorded on the unauthorized recording medium are recorded in a recording color of the hologram, i.e., green. FIG. 10B is a top view of an unauthorized recording medium 65 obtained when unauthorized copying is attempted using the hologram recording medium 60 according to the first embodiment as a master. In FIG. 10B, all G portions are recorded in green.

Therefore, hologram images recorded on the unauthorized recording medium 65 are clearly different from the hologram images observed from the genuine hologram recording medium, i.e., the hologram recording medium 60 according to the first embodiment. Genuineness determination for a hologram recording medium can be easily performed.

It is assumed that, imitating the diffuse reflection members 91y and 91r of the hologram recording medium 60 according to the first embodiment, yellowish reflection materials 93y and reddish reflection materials 93r are mixed in an adhesive layer of the unauthorized recording medium 65 after unauthorized copying is performed. In this case, as in the case explained above, it is difficult to erase the green hologram images due to the reflection of the diffuse reflection members 91y and 91r printed during the unauthorized recording. Therefore, as shown in FIG. 10C, green hologram images due to the reflection of not only the reflection materials 93y and 93r but also the diffuse reflection members 91y and 91r are observed. If such green patterns are left, the observer can instantaneously discriminate that the hologram that the observer is observing was subjected to unauthorized copying.

Moreover, the bonding power of the adhesive layer 92 to the adherend is set higher compared with self-binding power or breaking strength of the hologram recording layer 90. Therefore, it is possible to prevent the contact print from being performed with the diffuse reflection members 91y and 91r removed.

For example, when metal powder is mixed in the adhesive layer 92 of the hologram recording medium 60 according to the first embodiment as the diffuse reflection members 91, since it is random in which position of the adhesive layer 92 the metal powder appears, a positional relation between hologram images and the metal powder is unique. Therefore, in the unauthorized recording medium copied in an unauthorized manner using the hologram recording medium 60 according to the first embodiment as the master, hologram images of the metal powder are located in positions same as the positions of the hologram images. If there are a large number of hologram recording media in which the hologram images of the metal powder are recorded in the same positions, this means that unauthorized copying is performed concerning the genuine hologram recording medium.

### “Modification of the First Embodiment”

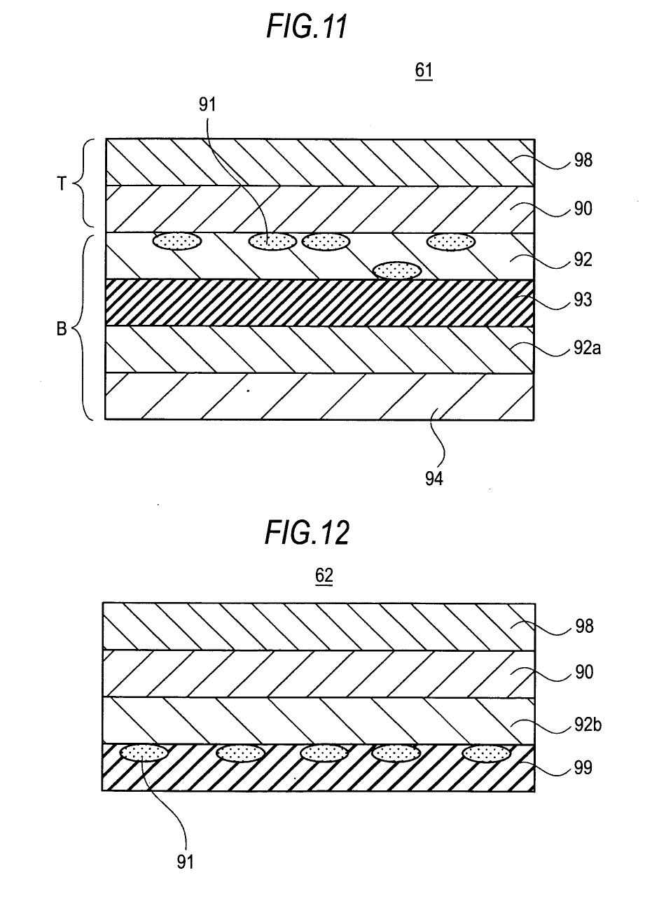

FIG. 11 is a diagram of an example of a hologram recording medium 61 including a black intermediate base material layer 93. As shown in the figure, a black layer may be provided on the inner side viewed from the observer with respect to the hologram recording layer 90 and the adhesive layer 92 in which the diffuse reflection members 91 are arranged. On the intermediate base material layer 93, an adhesive layer 92a for bonding to an adherend and a release layer 94 are formed. The black layer is provided on the inner side viewed from the observer with respect to the hologram recording layer 90 in this way in order to increase the contrast of an image of a hologram and make it easy to observe the hologram. Since the hologram diffracts light to the observer side, the contrast is the highest and the hologram can be most easily seen if a portion without hologram images is colored in a dark color, ideally, black. The black in this context is equal to or higher than 1.0 in OD (Optical Density), equal to or lower than 30 in brightness in the L*a*b color system specified in JIS Z 8729, or equal to or lower than 20% in average reflectance in the visible light domain wavelength of 400 to 750 nm. If the black is in the range explained above, an obtained result indicates that the hologram can be easily observed. The black layer may be a layer formed of, for example, paper.

Concerning adhesive performance of the adhesive layer 92 obtained when the diffuse reflection members 91 are mixed in the adhesive layer 92, it is appropriate to discuss the adhesive performance as volume content or weight density of the diffuse reflection members 91 with respect to the adhesive layer 92. However, an apparent effect substantially changes depending on the thickness of the adhesive layer 92. Therefore, when an effect of the mixing of the diffuse reflection members 91 is examined, it is advisable to consider a visible area of the diffuse reflection members 91 per unit area at the time when a hologram surface is observed from the vertical direction after the adhesive layer 92 is formed. In terms of a ratio of this area, the visible area of the diffuse reflection members 91 is desirably equal to or higher than 0.001% and equal to or lower than 50% and more desirably equal to or higher than 0.1% and equal to or lower than 10%. In this example, the ratio is set in a range of a ratio equal to or higher than 0.1% and equal to or lower than 10%. When the diffuse reflection members 91 are within this range, since the hologram recording medium 61 is blackish as a whole, the contrast of the hologram is increased and visibility is high. Moreover, an effect of counterfeit prevention measures can be sufficiently shown.

As the black intermediate base material layer 93, a polyethylene terephthalate film in which carbon or the like is dispersed may be used. An adhesive material kneaded with carbon or the like to a degree not reducing necessary adhesive power may be used in the adhesive layer 92a to form the adhesive layer 92a instead of the black intermediate layer. A layer in which a structure for suppressing reflection of light made incident from the upper surface is formed may be used rather than the black layer.

When such a structure is adopted, as in the first embodiment, the integrally-formed hologram recording medium 61 can be obtained by, after separately forming a T portion including the hologram recording layer 90 and a B portion including the adhesive layer 92 in which the diffuse reflection members 91 are arranged, combining the T portion and the B portion.

FIG. 12 is a diagram of an example in which the diffuse reflection members 91 are arranged in an adherend 99 rather than in the adhesive layer 92. In this example, an adhesive layer 92b is a transparent adhesive layer. The diffuse reflection members 91 arranged in the adherend 99 may be colored in, for example, a color close to gray as long as the diffuse reflection members 91 have transparency enabling observation from the upper surface of a hologram. In this example, in order to increase the contrast of an image of the hologram, a portion of the adherend 99 to which the hologram is bonded is desirably colored in black. However, the portion is not limited to black and may be colored in a color close to gray. The diffuse reflection members 91 are arranged in the adherend 99 not to be completely buried in the adherend 99.

### 3. Second Embodiment

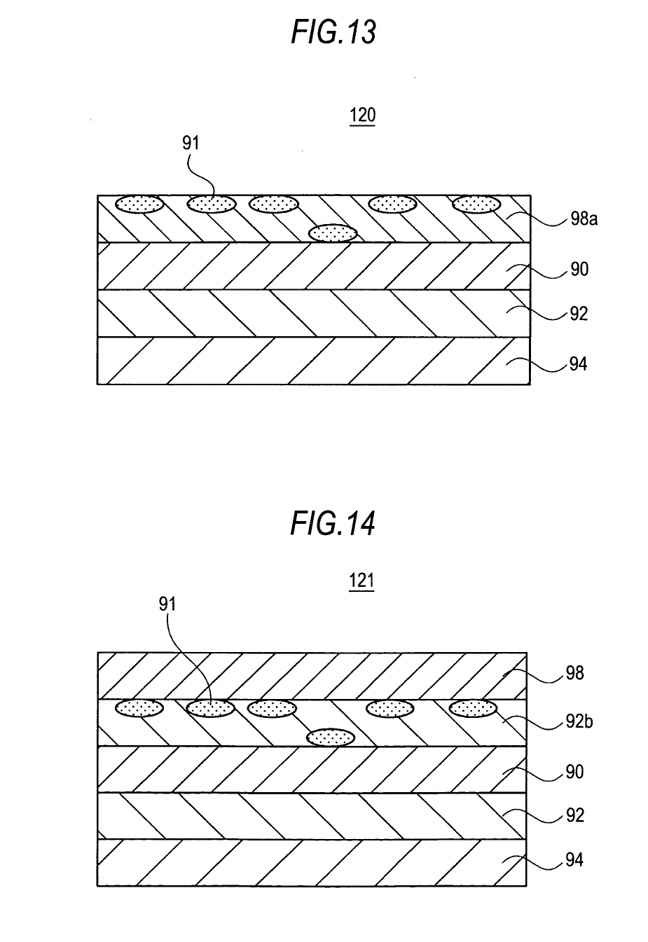

FIG. 13 is a sectional schematic diagram of a structure example of a laminated structure of a hologram recording medium according to a second embodiment of the present invention. In the structure example shown in FIG. 13, the second embodiment is the same as the first embodiment in that a protective layer, a hologram recording layer, an adhesive layer, and a release layer are laminated in order from an observer side of a hologram (the upper side in FIG. 13). The second embodiment is different from the first embodiment in that the diffuse reflection members 91 are arranged in a protective layer 98a on the observer side of the hologram rather than in the adhesive layer 92.

In the second embodiment, as in the first embodiment, in a hologram further copied in an unauthorized manner using a hologram recording medium 120 according to the second embodiment as a master, images of reflection members are recorded in an unauthorized recording medium. Therefore, there is an effect that it is seen that the hologram copied in an unauthorized manner using the hologram recording medium 120 according to the second embodiment as the master is different from a genuine hologram.

In the second embodiment, since the diffuse reflection members 91 are arranged further on the observer side than the hologram recording layer 90, the diffuse reflection members are observed on a reproduced image of the hologram. Therefore, the diffuse reflection members 91 are arranged to a degree not disturbing the reproduced image of the hologram.

### “Modification of the Second Embodiment”

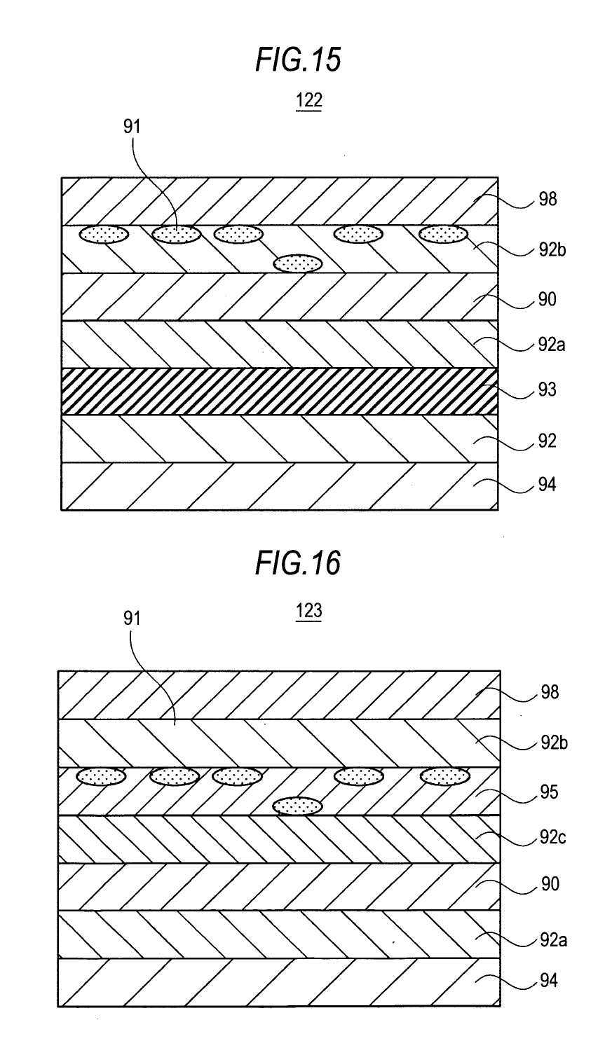

FIGS. 14, 15, and 16 are diagrams of examples of other layer structures. FIG. 14 is a diagram of an example of a layer structure in which the diffuse reflection members 91 are arranged in the adhesive layer 92b that bonds the protective layer 98 and the hologram recording layer 90. FIG. 15 is a diagram of an example of a layer structure further including the black intermediate base material layer 93. FIG. 16 is a diagram of an example of a layer structure in which an intermediate layer 95 having the diffuse reflection members 91 mixed in a transparent base material is arranged further on the observer side than the hologram recording layer 90.

As explained above, the diffuse reflection members 91 may be mixed in the protective layer, the intermediate base material layer, or the adhesive layer further on the observer side than the hologram recording layer 90. In this case, since the layer in which the diffuse reflection members are arranged is formed further on the front side than the hologram recording layer 90 with respect to the observer of the hologram, the adhesive layer on a side closer to the adherend than the hologram recording layer 90 may be colored in black or a color close to black. When the layer structure explained above is adopted, it is also possible to obtain the hologram recording media by bonding, after recording the hologram in the hologram recording layer 90, the layers or members in which the layers are laminated.

There may be plural layers in which the diffuse reflection members are arranged. Specifically, the diffuse reflection members may be arranged in plural adhesive layers or protective layers on the front side or plural adhesive layers or protective layers on the inner side with respect to the observer of the hologram recording layer. If different kinds of particles are arranged in the respective layers, the counterfeit prevention effect is higher than when one kind of particles are arranged in one layer. As plural light scattering layers, a large number of forms are conceivable such as a combination including one or more light scattering layers including resin layers and one or more light scattering layers including adhesive layers, a combination including one or more light scattering layers including resin layers and one or more light scattering layers including hot-melt adhesives, a combination including one or more light scattering layers including adhesive layers and one or more light scattering layers including hot-melt adhesives, and a combination including one or more light scattering layers including resin layers and one or more light scattering layers including hot-melt adhesives.

### 4. Modifications

The copy prevention holograms according to the several embodiments of the present invention are explained above. However, the present invention is not limited to the embodiments and various modifications of the embodiments are possible.

The diffuse reflection members 91 are not limited to the members explained above. For example, members such as diffraction grating pieces, embossed hologram pieces, or the like may be applied as the diffuse reflection members 91 as long as the members reflect, diffract, or refract reproduced color wavelength of a hologram. Members such as disc-like evaporated film pieces may be used. In this case, if a layer of the film pieces and the hologram recording layer 90 are close to parallel, hologram images recorded by unauthorized copying are images visible from the regular reflection direction. However, it is still easy to distinguish an original and an unauthorized copy.

It is also possible to form the diffuse reflection members as an inorganic film layer or an organic film layer and mix non-reflective particles in the layer. In this case, for example, when a thin film is formed by sputtering or the like, it is possible to simultaneously form particulates having different diffuse reflection states.

A blocking layer may be provided between the hologram recording layer 90 and the adhesive layer. In all the examples, bonding power of the adhesive layers included in the hologram recording media according to the embodiments is desirably set higher compared with self-binding power or breaking strength of the hologram recording layer 90.

The hologram explained in the embodiments are a volume type (or Lippmann type) for the purpose of preventing the contact copy. However, the present invention can also be applied to an embossed type.

The present application contains subject matter related to that disclosed in Japanese Priority Patent Application JP 2010-030706 filed in the Japan Patent Office on Feb. 15, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A hologram recording medium comprising:
a hologram recording layer; and
a light scattering layer, wherein
a material having a reflection characteristic different from that of a main material forming the light scattering layer is arranged in the light scattering layer.

2. A hologram recording medium according to claim 1, wherein, when the hologram recording layer and the light scattering layer are separated, the hologram recording layer and the light scattering layer are cut off involving cohesive failure of the hologram recording layer.

3. A hologram recording medium according to claim 1, wherein the hologram recording layer is a volume hologram or a volume holographic stereogram.

4. A hologram recording medium according to claim 1, wherein the light scattering layer is formed further on an inner side than the hologram recording layer with respect to an observer of a hologram.

5. A hologram recording medium according to claim 1, wherein the light scattering layer is formed further on a front side than the hologram recording layer with respect to an observer of a hologram.

6. A hologram recording medium according to claim 1, wherein the light scattering layer is a layer in which, in resin including a light transmitting member, a material having a reflection characteristic different from that of a main material forming a layer of the resin is arranged.

7. A hologram recording medium according to claim 1, wherein the light scattering layer is a layer in which, in an adhesive including a light transmitting member, a material having a reflection characteristic different from that of a main material forming the adhesive is arranged.

8. A hologram recording medium according to claim 1, wherein the light scattering layer is a layer in which, in a hot-melt adhesive including a light transmitting member, a material having a reflection characteristic different from that of a main material forming the hot-melt adhesive is arranged.

9. A hologram recording medium according to claim 1, wherein the light scattering layer includes plural layers.

10. A hologram recording medium according to claim 1, wherein the light scattering layer is a colored layer.

11. A hologram recording medium according to claim 1, further comprising a colored layer further on an inner side than the light scattering layer with respect to an observer of a hologram.

12. A hologram recording medium according to claim 10, wherein the colored layer is black.

13. A hologram recording medium according to claim 10, wherein the colored layer is a resin layer.

14. A hologram recording medium according to claim 10, wherein the colored layer is an adhesive layer.

15. A hologram recording medium according to claim 10, wherein the colored layer is a colored paper layer.
